(19) United States
(12) Patent Application Publication
(10) Pub. No.: US 2007/0005513 A1
(43) Pub. Date: Jan. 4, 2007

(54) IC chip, board, information processing equipment, and storage medium

(75) Inventors: Naoki Nishiguchi, Kawasaki (JP); Eiji Hasegawa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/355,098

(22) Filed: Feb. 16, 2006

(30) Foreign Application Priority Data
Jun. 30, 2005 (JP) 2005-192629

(51) Int. Cl. H04L 9/00

(52) U.S. Cl. 705/71

(57) ABSTRACT

An IC chip, a board, information processing equipment, and a storage medium are provided that can prevent, even when information is transferred between a plurality of programs, leaking of a right protection algorithm of information in connection with the transfer, by generating an encryption key using a separately provided secure module and encrypting information to be stored into a main memory. Information processing equipment includes a security board being mounted thereon an IC chip having a secure module. In the information processing equipment, the secure module receives an encryption key request signal, from an external CPU that executes a program for transferring information; generates a communication encryption key every time when the encryption key request signal is received, the communication encryption key being used to encrypt information to be transferred between a plurality of programs; and supplies the generated communication encryption key to the external CPU.

### CROSS-REFERENCE TO RELATED APPLICATIONS

This Nonprovisional application claims priority under 35 U.S.C. §119(a) on Patent Application No. 2005-192629 filed in Japan on Jun. 30, 2005, the entire contents of which are hereby incorporated by reference.

### BACKGROUND OF THE INVENTION

The present invention relates to an IC chip, a board, information processing equipment, and a storage medium that are capable of preventing, when data is transferred between a plurality of software programs through a memory, illegal use, tampering, and the like by third parties monitoring and analyzing the memory.

In recent years, broadband Internet, digital broadcasting, etc., have become widespread, and right protection techniques for assuring the security of distributed content (mainly digital AV content) have been receiving attention. When distributed content is reproduced through a dedicated receiver, unauthorized copying of the content and the like can be relatively easily prevented. On the other hand, when distributed content is reproduced using an electronic device having an open architecture, such as, in particular, a personal computer (hereinafter referred to as a “PC”) is reproduced, basically, memory analysis can be easily done by third parties, and thus it is difficult to ensure the security of the content. However, the PC is one of the major terminal devices for broadband Internet, and if the security of content can be assured, the potential for distributing digital AV content on the entire Internet will be dramatically improved.

Conventionally, for the right protection of a software program installed on a PC, execution of a secret process for an algorithm to assure security and a make-it-difficult-to-read process for making the analysis of an algorithm difficult are in the mainstream.

The former one is, for example, an encryption process using an encryption key, and the latter one is, for example, a process of making the analysis of an arithmetic process difficult by executing a complex process in which the results of arithmetic processing are the same.

### BRIEF SUMMARY OF THE INVENTION

The present invention is made in view of the foregoing problems. An object of the present invention is to provide an IC chip, a board, information processing equipment, and a storage medium that are capable of preventing, even when information is transferred between a plurality of programs, leaking of a right protection algorithm of information in connection with the transfer, by generating an encryption key using a separately provided secure module and encrypting information to be stored into a main memory.

Another object of the present invention is to provide an IC chip, a board, information processing equipment, and a storage medium, in which a generation history of encryption keys generated using a separately provided secure module is stored in the secure module, whereby even when the encryption key is changed an encryption key can be easily re-obtained by analyzing a past generation history, and the occurrence of a situation where information cannot be decrypted can be prevented in a state in which a high security level is maintained.

To attain the objects mentioned above, in an IC chip according to a first aspect of the present invention having a secure module with a structure that does not allow information stored in the IC chip to be read from outside, the secure module comprises: a receiving unit that receives an encryption key request signal that is a request for supply of a communication encryption key, from an external CPU that executes a program for transferring information; a generating unit that generates a communication encryption key every time when the encryption key request signal is received, the communication encryption key being used to encrypt information to be transferred between a plurality of programs; and a supplying unit that supplies the generated communication encryption key to the external CPU that executes a program which sends the encryption key request signal.

An IC chip according to a second aspect of the present invention is such that in the first aspect the secure module further comprises: a storage unit that stores historical information about generation of the communication encryption key; an extracting unit that extracts a necessary communication encryption key by referring to the historical information; and a supplying unit that supplies the extracted communication encryption key to the external CPU that executes a program which sends the encryption key request signal.

A board according to a third aspect of the present invention has installed thereon the IC chip according to either the first or second aspect.

In information processing equipment according to a fourth aspect of the present invention including: a memory having stored therein information that can be read from outside; and a CPU that executes a program stored into the memory, the information processing equipment transferring information between a plurality of programs stored into the memory, the information processing equipment comprises: the board according to the third aspect; an encrypting unit that encrypts information to be transferred, using the supplied communication encryption key; a transmitting and receiving unit that transmits and receives the encrypted information; and a decrypting unit that decrypts the received encrypted information.

Information processing equipment according to a fifth aspect of the present invention is such that in the fourth aspect the secure module further comprises: a storage unit that stores historical information about generation of the communication encryption key; an extracting unit that extracts a necessary communication encryption key by referring to the historical information; and a supplying unit that supplies the extracted communication encryption key to the external CPU that executes a program which sends the- encryption key request signal.

In a storage medium according to a sixth aspect of the present invention having stored therein a computer program that causes a computer to function as a secure module having stored therein information that cannot be read from outside, the computer is caused to function as: a receiving unit that receives an encryption key request signal that is a request for supply of a communication encryption key, from an external CPU that executes a program for transferring information; a generating unit that generates a communication encryption key every time when the encryption key request signal is received, the communication encryption key being used to encrypt information to be transferred between a plurality of programs; and a supplying unit that supplies the generated communication encryption key to the external CPU that executes a program which sends the encryption key request signal.

A storage medium according to a seventh aspect of the present invention is such that in the sixth aspect the computer is caused to further function as: a storage unit that stores historical information about generation of the communication encryption key; an extracting unit that extracts a necessary communication encryption key by referring to the historical information; and a supplying unit that supplies the extracted communication encryption key to the external CPU that executes a program which sends the encryption key request signal.

In the first, third, fourth, and sixth aspects, a secure module having a structure that does not allow information stored in the IC chip to be read from the outside is provided, and the secure module receives an encryption key request signal that is a request for supply of a communication encryption key, from an external CPU that executes a program for transferring information; generates a communication encryption key every time when the encryption key request signal is received, the communication encryption key being used to encrypt information to be transferred between a plurality of programs; and supplies the generated communication encryption key to the external CPU that executes a program which sends the encryption key request signal. By this, in the secure module having received a request for generation of a communication encryption key from a program for transferring information, the communication encryption key being used to encrypt information to be transferred, a unique communication encryption key is generated on every request and information to be transferred is encrypted using the generated communication encryption key; therefore, it becomes difficult to analyze the stored contents of the memory in the process of transferring information between programs, i.e., the contents of the memory in the process of executing a program, to identify a communication encryption key. Even if the communication encryption key is identified, since the communication encryption key can be changed as appropriate, information cannot be decrypted using the identified communication encryption key, and accordingly, the illegal leaking of content can be effectively prevented.

In the second, fifth, and seventh aspects, the secure module stores therein historical information about generation of the communication encryption key, extracts a necessary communication encryption key by referring to the historical information, and supplies the extracted communication encryption key to the sender of the encryption key request signal. By storing historical information about a changed communication encryption key in the secure module having stored therein information that cannot be read from the outside, even if the communication encryption key being used for encryption is not the latest communication encryption key, a communication encryption key that enables decryption can be easily extracted, making it possible to prevent a situation where information cannot be decrypted.

In the first, third, fourth, and sixth aspects, in the secure module having received a request for generation of a communication encryption key from a program for transferring information, the communication encryption key being used to encrypt information to be transferred, a unique communication encryption key is generated on every request and information to be transferred is encrypted using the generated communication encryption key; therefore, it becomes difficult to analyze the stored contents of the memory in the process of transferring information between programs, i.e., the contents of the memory in the process of executing a program, to identify a communication encryption key. Even if the communication encryption key is identified, since the communication encryption key can be changed as appropriate, information cannot be decrypted using the identified communication encryption key, and accordingly, the illegal leaking of content can be effectively prevented.

In the second, fifth, and seventh aspects, by storing historical information about a changed communication encryption key in the secure module having stored therein information that cannot be read from the outside, even if the communication encryption key being used for encryption is not the latest communication encryption key, a communication encryption key that enables decryption can be easily extracted, making it possible to prevent a situation where information cannot be decrypted.

The above and further objects and features of the invention will more fully be apparent from the following detailed description with accompanying drawings.

### BRIEF DESCRIPTION OF THE SEVERAL VIEWS OF THE DRAWINGS

FIG. 1 is a block diagram showing a configuration of information processing equipment according to a first embodiment of the present invention;

FIG. 2 is a flowchart showing process steps performed by a secondary CPU on an IC chip according to the first embodiment of the present invention;

FIG. 3 is an exemplary diagram showing a data configuration of an encryption key request signal;

FIG. 4 is a flowchart showing process steps performed by the secondary CPU on the IC chip to encrypt a communication encryption key;

FIG. 5 is a block diagram showing a configuration of information processing equipment according to a second embodiment of the present invention; and

FIG. 6 is a flowchart showing process steps performed by a secondary CPU on an IC chip according to the second embodiment of the present invention.

### DETAILED DESCRIPTION OF THE INVENTION

As described above, when a software program is executed on a PC, the program is always loaded into a main memory and then executed. Thus, by copying the stored contents of the main memory and analyzing the copied contents, the details of the aforementioned right protection algorithm can be grasped only if there is sufficient time to do so. In addition, if, for example, the stored contents of the main memory are analyzed and a storage location of an encryption key being used for an encryption process is identified, the right protection algorithm of the software program is leaked.

In view of this, for example, information processing equipment is developed in which a secure module having a structure that does not allow the stored contents to be read from the outside is separately provided. The information processing equipment prevents, even if the stored contents of the main memory are analyzed and a storage location of an encryption key for an encryption process is identified, the right protection algorithm of the software program from being leaked, by storing the encryption key in the secure module.

By separately providing a secure module, as long as information is processed by a single software program, the possibility that the right protection algorithm may be leaked is very little. However, depending on the application, a plurality of software programs may be simultaneously executed and there may be a program for transferring information between the programs. In this case, by analyzing the stored contents of the main memory upon the transfer, the possibility remains that information having been subjected to an encryption process may be inappropriately taken.

The present invention is made in view of the foregoing problems. An object of the present invention is to provide an IC chip, a board, information processing equipment, and a storage medium that are capable of preventing, even when information is transferred between a plurality of programs, leaking of a right protection algorithm of information in connection with the transfer, by generating an encryption key using a separately provided secure module and encrypting information to be stored into a main memory. The present invention will now be illustrated by the following embodiments.

(First Embodiment)

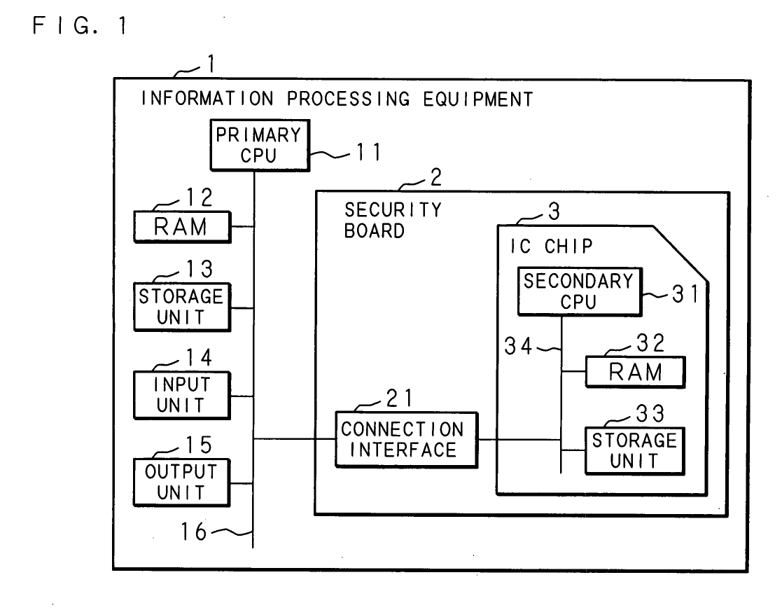

FIG. 1 is a block diagram showing a configuration of information processing equipment according to a first embodiment of the present invention. In the information processing equipment according to the first embodiment, a security board 2 for maintaining security is connected to an arithmetic processing unit including a primary CPU 11 as the main component. The security board 2 is connected to the arithmetic processing unit through an internal bus 16 and a connection interface 21, and has an IC chip 3 mounted thereon. The information processing equipment 1 includes at least the primary CPU 11, RAM 12, a storage unit 13, an input unit 14, an output unit 15, and the security board 2. The components are connected to one another through the internal bus 16.

The primary CPU 11 is connected through the internal bus 16 to each of the hardware components, such as those described above, of the information processing equipment 1. The primary CPU 11 controls the aforementioned hardware components, and allows programs, such as a program for receiving digital content, a program for encrypting/decrypting the received digital content, and a program for transferring data between a plurality of programs, which are stored in the storage unit 13 such as a hard disk, to be loaded into the RAM 12, thereby executing various software functions.

The RAM 12 is composed of DRAM or the like. In the RAM 12, a program stored in the storage unit 13, such as a program for receiving digital content, a program for encrypting/decrypting the received digital content, or a program for transferring data between a plurality of programs, is loaded upon its execution, and temporary data generated upon execution is stored.

The input unit 14 is an input medium necessary to operate the information processing equipment 1, such as a keyboard having character keys, a numeric keypad, various function keys, and the like, or a mouse. The output unit 15 is, for example, a display device such as a liquid crystal display device or a CRT display, or a printing device such as a laser printer or a dot printer.

The security board 2 includes at least the connection interface 21 connected to the primary CPU 11 through the internal bus 16; and the IC chip 3. The IC chip 3 is configured as a secure module having a structure that does not allow information stored in the IC chip 3 to be read from the outside. The IC chip 3 includes at least a secondary CPU 31, RAM 32, and a storage unit 33. The storage unit 33 stores therein a program for generating, when an encryption key request signal is received, a communication encryption key being used to perform an encryption process on information to be transferred between programs, a program for supplying the generated communication encryption key, and the like.

The secondary CPU 31 is connected through an internal bus 34 to each of the hardware components, such as those described above, of the IC chip 3. The secondary CPU 31 controls the aforementioned hardware components, and allows various programs stored in the storage unit 33 to be loaded into the RAM 32, thereby executing various software functions.

The processes performed by the primary CPU 11 and the secondary CPU 31 in the information processing equipment 1 having the aforementioned configuration will be described below. The first embodiment explains the transfer of digital content between a plurality of programs. Note that it is assumed in the first embodiment that the authenticity of a program to be executed is assured by other means. Note also that information about an address in the RAM 12 where a program is loaded and about an address in the RAM 12 to which a communication encryption key for each individual program is recorded is stored in advance in the RAM 32 on the IC chip 3 by other means.

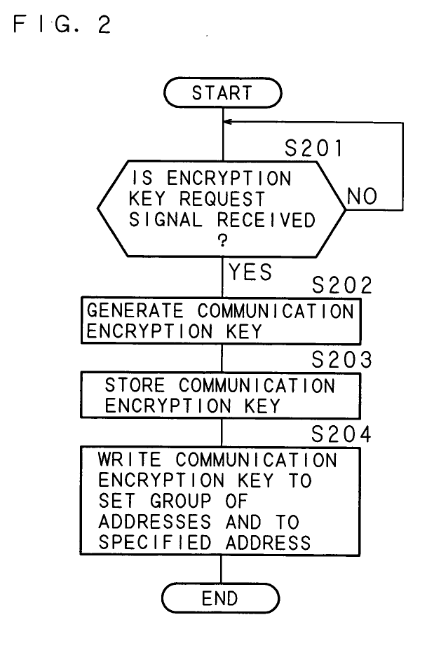

FIG. 2 is a flowchart showing process steps performed by the secondary CPU 31 on the IC chip 3 according to the first embodiment of the present invention. When digital content is transferred between a plurality of programs, the primary CPU 11 of the information processing equipment 1 sends an encryption key request signal to the IC chip 3 in response to an instruction from a program that is the sender of the digital content. The secondary CPU 31 on the IC chip 3 receives the encryption key request signal (“YES” at step S201).

Note that the timing at which the primary CPU 11 of the information processing equipment 1 sends an encryption key request signal to the IC chip 3 in response to an instruction from a program that is the sender of the digital content is not limited to the one described above in which an encryption key request signal is sent every time when digital content is transferred; an encryption key request signal may be sent at a certain interval. Note also that an encryption key request signal may be part of a process command.

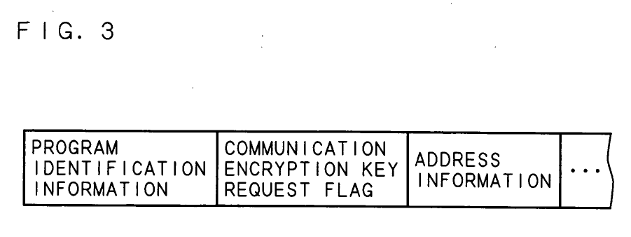

FIG. 3 is an exemplary diagram showing a data configuration of an encryption key request signal. An encryption key request signal contains at least information identifying a program; information indicating a request for a communication encryption key; and address information about where to store the communication encryption key into the RAM 12. The information identifying a program may be a program ID or may be an address range in the RAM 12 where the program is loaded. The information indicating a request for a communication encryption key is sent with a request flag being set to “1”, for example. When address information about where to store the communication encryption key into the RAM 12 is specified, the communication encryption key is stored to a specified address. On the other hand, when the address information is not specified, the communication encryption key is stored to a group of addresses, the information of which is stored in advance in the RAM 32 on the IC chip 3.

The secondary CPU 31 having received the encryption key request signal generates a communication encryption key (step S202). The secondary CPU 31 stores the generated communication encryption key in the storage unit 33 on the IC chip 3 (step S203).

The secondary CPU 31 writes the generated communication encryption key to the group of addresses in the RAM 12, the information of which is stored in advance in the RAM 32 on the IC chip 3 (step S204). The primary CPU 11 of the information processing equipment 1 monitors whether the communication encryption key is written to the specified address. If the primary CPU 11 determines that the communication encryption key is written to the specified address, the primary CPU 11 performs an encryption process on the digital content to be transferred, using the written communication encryption key. The primary CPU 11 transfers the encrypted digital content to another program, and the another program having received the encrypted digital content decrypts the digital content using the communication encryption key written to a predetermined address.

As described above, according to the first embodiment, the process of generating a communication encryption key is performed within the IC chip 3 whose contents cannot be read from the outside, and an encryption process and a decryption process are performed within a program execution area that is protected by a conventional technique, and therefore, even when digital content is transferred between programs, it is difficult to identify the communication encryption key being used upon the transfer. In addition, even if the communication encryption key is identified, since the communication encryption key can be changed as appropriate, information cannot be decrypted using the identified communication encryption key, and accordingly, the illegal leaking of content can be effectively prevented.

Note that when a generated communication encryption key is stored into the RAM 12, the address to be stored to may be changed each time. In this case, upon storing a communication encryption key, information about an address to be stored to next time may be provided, or a pointer to an address to which a communication encryption key is actually stored may be stored to an address to which a communication encryption key is stored and the secondary CPU 31 may randomly assign an address to which the actual communication encryption key is stored.

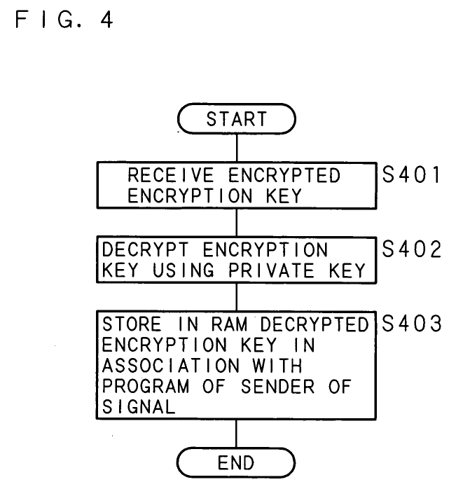

A communication encryption key itself may be encrypted using another encryption key. FIG. 4 is a flowchart showing process steps performed by the secondary CPU 31 on the IC chip 3 to encrypt a communication encryption key. FIG. 4 explains the encryption of a communication encryption key using a public-key system. Needless to say, encryption is not limited to a public-key system and a private-key system may be used.

In the RAM 32 on the IC chip 3, a private key corresponding to a public key is stored. The primary CPU 11 of the information processing equipment 1 encrypts, using a public key, an encryption key being used to encrypt a communication encryption key, and sends the encrypted encryption key to the IC chip 3 by a signal different from an encryption key request signal.

The secondary CPU 31 receives the encrypted encryption key (step S401), and decrypts the received encryption key using the private key stored in the RAM 32 (step S402). The secondary CPU 31 stores in the RAM 32 the decrypted encryption key in association with a program ID (step S403). The secondary CPU 31 encrypts, upon receiving an encryption key request signal and generating a communication encryption key, the communication encryption key using the encryption key stored in the RAM 32, and stores in the RAM 12 the encrypted communication encryption key. By this, different encryption keys can be stored for different programs, and a single communication encryption key is encrypted using an encryption key that varies with each program and the encrypted communication encryption key is stored in the RAM 12.

When a communication encryption key is generated in response to an encryption key request signal, the primary CPU 11 determining that the communication encryption key is stored to a predetermined address in the RAM 12 decrypts the encrypted communication encryption key using a known encryption key. Then, using the decrypted communication encryption key, received digital content is encrypted/decrypted.

By doing so, a communication encryption key can be transferred more securely between a plurality of programs that transfer digital content to each other, and the illegal leaking of content can be more effectively prevented.

(Second Embodiment)

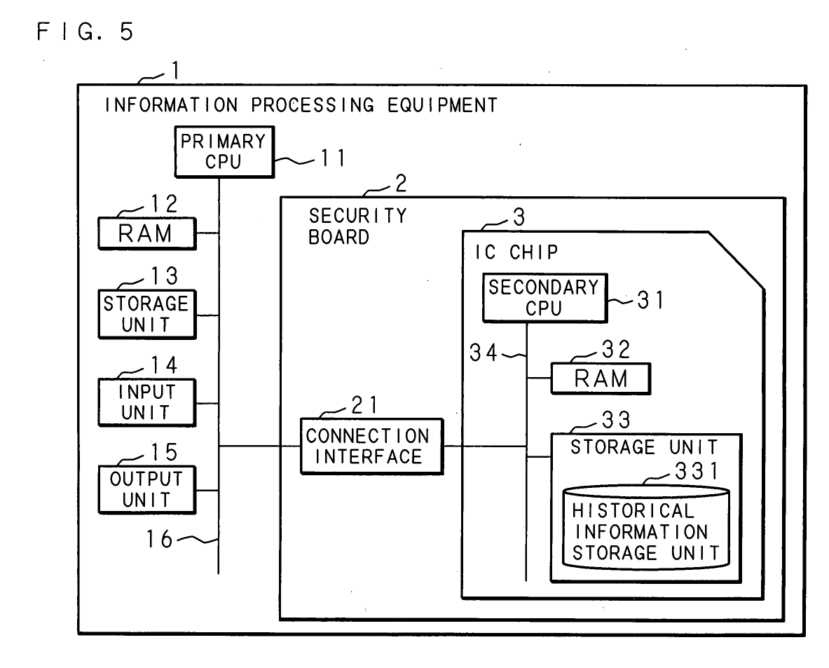

FIG. 5 is a block diagram showing a configuration of information processing equipment according to a second embodiment of the present invention. As in the first embodiment, in the information processing equipment according to the second embodiment, a security board 2 for maintaining security is connected to an arithmetic processing unit including a primary CPU 11 as the main component. The security board 2 is connected to the arithmetic processing unit through an internal bus 16 and a connection interface 21, and has an IC chip 3 maunted thereon. The information processing equipment 1 includes at least the primary CPU 11, RAM 12, a storage unit 13, an input unit 14, an output unit 15, and the security board 2. The components are connected to one another through the internal bus 16.

The security board 2 includes at least the connection interface 21 connected to the primary CPU 11 through the internal bus 16; and the IC chip 3. The IC chip 3 is configured as a secure module having a structure that does not allow information stored in the IC chip 3 to be read from the outside. The IC chip 3 includes at least a secondary CPU 31, RAM 32, and a storage unit 33. The storage unit 33 stores therein a program for generating, when an encryption key request signal is received, a communication encryption key being used to perform an encryption process on information to be transferred between programs, a program for supplying the generated communication encryption key, and the like. In addition, a generated communication encryption key is stored in a historical information storage unit 331 in the storage unit 33 so as to be associated with information that identifies the generated communication encryption key, for example, a communication encryption key number.

The secondary CPU 31 is connected through an internal bus 34 to each of the hardware components, such as those described above, of the IC chip 3. The secondary CPU 31 controls the aforementioned hardware components, and allows various programs stored in the storage unit 33 to be loaded into the RAM 32, thereby executing various software functions.

The processes performed by the primary CPU 11 and the secondary CPU 31 in the information processing equipment 1 having the aforementioned configuration will be described below. The second embodiment explains the transfer of digital content between a plurality of programs. Note that it is assumed in the second embodiment that the authenticity of a program to be executed is assured by other means. Note also that information about an address in the RAM 12 where a program is loaded and about an address in the RAM 12 to which a communication encryption key for each individual program is recorded is stored in advance in the RAM 32 on the IC chip 3 by other means.

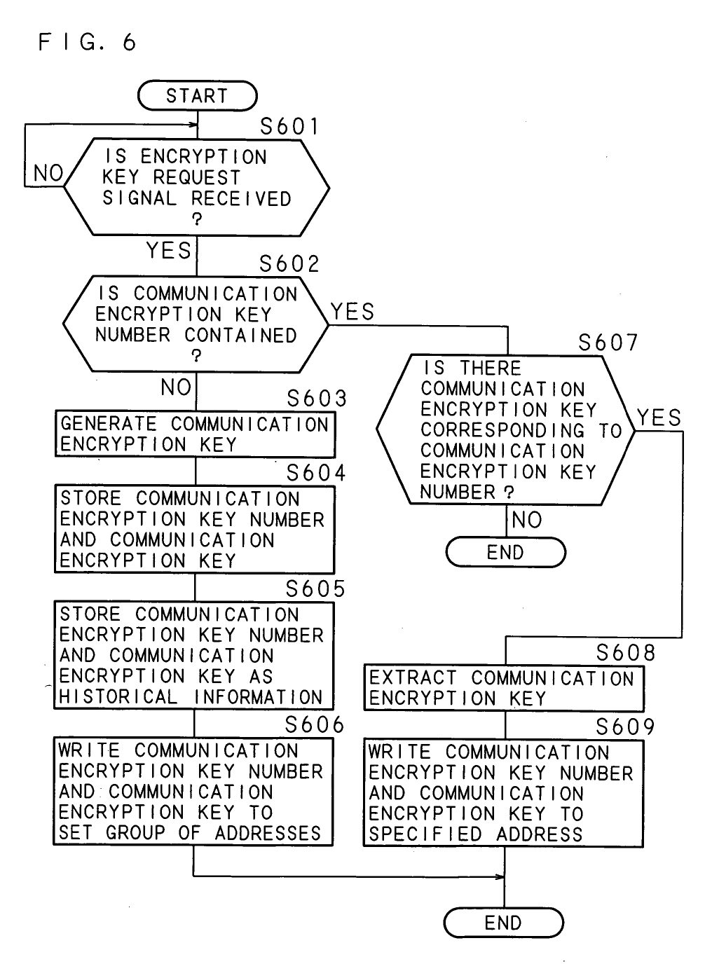

FIG. 6 is a flowchart showing process steps performed by the secondary CPU 31 on the IC chip 3 according to the second embodiment of the present invention. When digital content is transferred between a plurality of programs, the primary CPU 11 of the information processing equipment 1 sends an encryption key request signal to the IC chip 3 in response to an instruction from a program that is the sender of the digital content. The secondary CPU 31 on the IC chip 3 receives the encryption key request signal (“YES” at step S601).

Note that the timing at which the primary CPU 11 of the information processing equipment 1 sends an encryption key request signal to the IC chip 3 in response to an instruction from a program that is the sender of the digital content is not limited to the one described above in which an encryption key request signal is sent every time when digital content is transferred; an encryption key request signal may be sent at a certain interval. Note also that an encryption key request signal may be part of a process command. The data configuration of an encryption key request signal is the same as that in the first embodiment.

The secondary CPU 31 having received the encryption key request signal determines whether the encryption key request signal contains a communication encryption key number (step S602). If the secondary CPU 31 determines that the encryption key request signal does not contain a communication encryption key number (“No” at step S602), the secondary CPU 31 determines that a communication encryption key has not been generated, i.e., the transfer of digital content between programs has not been performed, and generates a communication encryption key (step S603). The secondary CPU 31 assigns a communication encryption key number to the communication encryption key and stores in the storage unit 33 on the IC chip 3 the communication encryption key number in association with the communication encryption key (step S604). In addition, the secondary CPU 31 stores in the historical information storage unit 331 on the IC chip 3 the communication encryption key and the communication encryption key number as historical information (step S605).

The secondary CPU 31 writes the generated communication encryption key and communication encryption key number to a group of addresses in the RAM 12, the information of which is written in advance in the RAM 32 on the IC chip 3 (step S606). The primary CPU 11 of the information processing equipment 1 monitors whether the communication encryption key is written to a specified address. If the primary CPU 11 determines that the communication encryption key is written to the specified address, the primary CPU 11 performs an encryption process on the digital content to be transferred, using the stored communication encryption key. The primary CPU 11 transfers the encrypted digital content to another program, and executes received another program, whereby the digital content is decrypted using the communication encryption key stored to a predetermined address. If the communication encryption key for the received digital content is different from the one stored in the RAM 12, in response to an instruction from a program having received the digital content, the primary CPU 11 sends an encryption key request signal to the IC chip 3. The primary CPU 11 sends the encryption key request signal with a necessary communication encryption key number contained therein.

The secondary CPU 31 on the IC chip 3 receives the encryption key request signal (step S601), and determines whether the encryption key request signal contains a communication encryption key number (step S602). If the secondary CPU 31 determines that the encryption key request signal contains a communication encryption key number (“YES” at step S602), the secondary CPU 31 determines that a communication encryption key has already been generated, i.e., the transfer of digital content between programs has been performed, and determines whether a communication encryption key corresponding to the communication encryption key number can be extracted from the historical information storage unit 331 (step S607).

If the secondary CPU 31 determines that a communication encryption key corresponding to the communication encryption key number can be extracted from the historical information storage unit 331 (“YES” at step S607), the secondary CPU 31 extracts the corresponding communication encryption key (step S608), and writes, as an decryption key (the same key in a private-key system) for the encrypted digital content, the extracted communication encryption key and communication encryption key number to an address in the RAM 12 that is specified by the encryption key request signal (step S609).

If the secondary CPU 31 determines that a communication encryption key corresponding to the communication encryption key number cannot be extracted from the storage unit 33 (“NO” at step S607), the secondary CPU 31 determines that there is no corresponding communication encryption key, and completes processing.

The primary CPU 11 of the information processing equipment 1 monitors whether the communication encryption key is written to a specified address. If the primary CPU 11 determines that the communication encryption key is written to the specified address, the primary CPU 11 performs a decryption process on received digital content using the stored communication encryption key.

As described above, according to the second embodiment, when digital content is transferred between programs, even if, after encrypting digital content to be transferred using a communication encryption key, a communication encryption key is newly generated, by referring to historical information a communication encryption key (decryption key) generated in the past can be surely obtained, making it possible to prevent the occurrence of a situation, for example, where encrypted digital content cannot be decrypted. In addition, by the primary CPU 11 issuing a command to the secondary CPU 31, even when a historical information acquisition request is explicitly made, a communication encryption key generated in the past can be surely obtained while the security of digital content to be transferred between programs is ensured.

Note that when a generated communication encryption key is stored into the RAM 12, the address to be stored to may be changed each time. In this case, upon storing a communication encryption key and a communication encryption key number, information about an address to be stored to next time may be provided, or a pointer to an address to which a communication encryption key is actually stored may be stored to an address to which a communication encryption key is stored and the secondary CPU 31 may randomly assign an address to which the actual communication encryption key is stored.

As in the first embodiment, a communication encryption key itself may be encrypted using another encryption key; in this case too, the same advantageous effects can be expected.

Although the first and second embodiments explain the storing of a communication encryption key into the RAM 12 of the information processing equipment 1 in response to an instruction from the secondary CPU 31 of a secure module, the present invention is not limited to the configurations according to the first and second embodiments. Any method can be used as long as the method enables the transfer of a communication encryption key while ensuring security; for example, a communication encryption key may be transmitted and received between CPUs. Although the foregoing embodiments explain the case where the IC chip 3 handles a single communication encryption key, even when the IC chip 3 handles a plurality of communication encryption keys, the same advantageous effects can be expected.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. An IC chip having a secure module storing information that cannot be read from outside, wherein
the secure module comprises:
a receiving means for receiving an encryption key request signal that is a request for supply of a communication encryption key, from an external CPU that executes a program for transferring information;
a generating means for generating a communication encryption key every time when the encryption key request signal is received, the communication encryption key being used to encrypt information to be transferred between a plurality of programs; and
a supplying means for supplying the generated communication encryption key to the external CPU that executes a program which sends the encryption key request signal.

2. The IC chip according to claim 1, wherein
the secure module further comprises:
a storage means for storing historical information about generation of the communication encryption key;
an extracting means for extracting a necessary communication encryption key by referring to the historical information; and
a supplying means for supplying the extracted communication encryption key to the external CPU that executes a program which sends the encryption key request signal.

3. An IC chip having a secure module storing information that cannot be read from outside, wherein
the secure module comprises a processor capable of performing the operations of:
receiving an encryption key request signal that is a request for supply of a communication encryption key, from an external CPU that executes a program for transferring information;
generating a communication encryption key every time when the encryption key request signal is received, the communication encryption key being used to encrypt information to be transferred between a plurality of programs; and
supplying the generated communication encryption key to the external CPU that executes a program which sends the encryption key request signal.

4. The IC chip according to claim 3, wherein
the secure module comprises the processor further capable of performing the operations of:
storing historical information about generation of the communication encryption key;
extracting a necessary communication encryption key by referring to the historical information; and
supplying the extracted communication encryption key to the external CPU that executes a program which sends the encryption key request signal.

5. A board being mounted thereon the IC chip according to claim 1.

6. A board being mounted thereon the IC chip according to claim 2.

7. A board being mounted thereon the IC chip according to claim 3.

8. A board being mounted thereon the IC chip according to claim 4.

9. Information processing equipment including: a memory storing information that can be read from outside; a CPU that executes a program stored into the memory; and the board according to claim 5, the information processing equipment transferring information between a plurality of programs stored into the memory, and comprising:
an encrypting means for encrypting information to be transferred, using the supplied communication encryption key;
a transmitting and receiving means for transmitting and receiving the encrypted information; and
a decrypting means for decrypting the received encrypted information.

10. Information processing equipment including: a memory storing information that can be read from outside; a CPU that executes a program stored into the memory; and the board according to claim 6, the information processing equipment transferring information between a plurality of programs stored into the memory, and comprising:
an encrypting means for encrypting information to be transferred, using the supplied communication encryption key;
a transmitting and receiving means for transmitting and receiving the encrypted information; and
a decrypting means for decrypting the received encrypted information.

11. Information processing equipment including: a memory storing information that can be read from outside; a CPU that executes a program stored into the memory; and the board according to claim 7, the information processing equipment transferring information between a plurality of programs stored into the memory, and comprising the processor further capable of performing the operations of:
encrypting information to be transferred, using the supplied communication encryption key;
transmitting and receiving the encrypted information; and
decrypting the received encrypted information.

12. Information processing equipment including: a memory storing information that can be read from outside; a CPU that executes a program stored into the memory; and the board according to claim 8, the information processing equipment transferring information between a plurality of programs stored into the memory, and comprising the processor further capable of performing the operations of:
encrypting information to be transferred, using the supplied communication encryption key;
transmitting and receiving the encrypted information; and
decrypting the received encrypted information.

13. The information processing equipment according to claim 9, wherein the secure module further comprises:
a storage means for storing historical information about generation of the communication encryption key;
an extracting means for extracting a necessary communication encryption key by referring to the historical information; and
a supplying means for supplying the extracted communication encryption key to the external CPU that executes a program which sends the encryption key request signal.

14. The information processing equipment according to claim 10, wherein the secure module comprises:
a storage means for storing historical information about generation of the communication encryption key;
an extracting means for extracting a necessary communication encryption key by referring to the historical information; and
a supplying means for supplying the extracted communication encryption key to the external CPU that executes a program which sends the encryption key request signal.

15. The information processing equipment according to claim 11, wherein the secure module comprises the processor further capable of performing the operations of:
storing historical information about generation of the communication encryption key;
extracting a necessary communication encryption key by referring to the historical information; and
supplying the extracted communication encryption key to the external CPU that executes a program which sends the encryption key request signal.

16. The information processing equipment according to claim 12, wherein the secure module comprises the processor capable of performing the operations of:
storing historical information about generation of the communication encryption key;
extracting a necessary communication encryption key by referring to the historical information; and
supplying the extracted communication encryption key to the external CPU that executes a program which sends the encryption key request signal.

17. A storage medium storing a computer program for a computer which causes a computer to function as a secure module having stored information that cannot be read from outside, the computer program comprising the steps of:
causing the computer to receive an encryption key request signal that is a request for supply of a communication encryption key, from an external CPU that executes a program for transferring information;
causing the computer to generate a communication encryption key every time when the encryption key request signal is received, the communication encryption key being used to encrypt information to be transferred between a plurality of programs; and
causing the computer to supply the generated communication encryption key to the external CPU that executes a program which sends the encryption key request signal.

18. The storage medium according to claim 17, wherein the computer program comprises the further steps of:
causing the computer to store historical information about generation of the communication encryption key;
causing the computer to extract a necessary communication encryption key by referring to the historical information; and
causing the computer to supply the extracted communication encryption key to the external CPU that executes a program which sends the encryption key request signal.
